(19) United States
(12) Patent Application Publication
(10) Pub. No.: US 2024/0258600 A1
(43) Pub. Date: Aug. 1, 2024

(54) BATTERY CELL ASSEMBLY AND BATTERY PACK INCLUDING BATTERY CELL ASSEMBLY

(71) Applicant: SK ON CO., LTD., Seoul (KR)

(72) Inventors: Hyun Seok KIM, Daejeon (KR); Young Man KIM, Daejeon (KR)

(21) Appl. No.: 18/403,407

(22) Filed: Jan. 3, 2024

(30) Foreign Application Priority Data
Jan. 27, 2023 (KR) 10-2023-0011028

(51) Int. Cl. H01M 10/613; H01M 10/647; H01M 10/6554; H01M 50/105; H01M 50/211; H01M 50/507; H01M 50/55

(52) U.S. Cl. CPC H01M 10/613; H01M 10/647; H01M 10/6554; H01M 50/105; H01M 50/211; H01M 50/507; H01M 50/55

(57) ABSTRACT

The battery cell assembly includes an assembly housing, and a battery cell, a first busbar member and a second busbar member accommodated in the assembly housing. The first busbar member is connected to a first electrode lead of the battery cell and the second busbar member is connected to a second electrode lead of the battery cell. The battery cell assembly also includes first and second terminal units connected to the first and second busbar members, respectively. At least portions of the first terminal unit and the second terminal unit extend toward a first surface of the assembly housing and disposed outside of the assembly housing. The assembly housing includes an accommodation space in which the battery cell is accommodated and an open slot formed by opening a second surface of the assembly housing to connect the accommodation space to the outside of the accommodation space.

### CROSS-REFERENCE TO RELATED APPLICATION(S)

This patent document claims the priority and benefits of Korean Patent Application No. 10-2023-0011028 filed on Jan. 27, 2023, the disclosure of which is incorporated herein by reference in its entirety.

### TECHNICAL FIELD

The disclosed technology relates to a battery cell assembly and a battery pack including the same.

### BACKGROUND

Secondary batteries are widely used in mobile electronic devices such as mobile phones and laptops, as well as electric vehicles (EVs), and have the advantage of being rechargeable and reusable.

Such secondary batteries may be used in the form of secondary battery cells by placing an electrode assembly including a positive electrode plate, a negative electrode plate, and a separator in a case, injecting an electrolyte into the case, and then sealing the case.

### SUMMARY

The disclosed technology can be implemented in some embodiments to provide a battery cell assembly or battery pack that can improve manufacturing efficiency and facilitate mass production.

The disclosed technology can be implemented in some embodiments to provide a battery cell assembly or battery pack having improved reliability.

A battery cell assembly and battery pack based on some embodiments of the disclosed technology may be widely applied to green technology fields such as electric vehicles, battery charging stations, and solar power generation and wind power generation. In addition, a battery module based on some embodiments of the disclosed technology may be used in eco-friendly electric vehicles and hybrid vehicles to reduce climate change by suppressing air pollution and greenhouse gas emissions.

In some embodiments of the disclosed technology, a battery cell assembly may include an assembly housing, a battery cell accommodated in the assembly housing, a first busbar member and a second busbar member accommodated in the assembly housing, the first busbar member connected to a first electrode lead of the battery cell and the second busbar member connected to a second electrode lead of the battery cell, and a first terminal unit connected to the first busbar member and a second terminal unit connected to the second busbar member. In some implementations, the term “busbar” can be used to indicate a bar that carries/distributes electricity. In some implementations, the term “terminal unit” may be used to indicate a battery terminal, which is an electrical contact that connects a charger or load to a battery. At least portions of the first terminal unit and the second terminal unit may extend toward one surface of the assembly housing to be present outside of the assembly housing. The assembly housing may include an accommodation space in which the battery cell is accommodated, and an open slot formed by opening the other surface thereof to connect the accommodation space to the outside of the accommodation space. The open slot may be formed in the assembly housing to be oriented in an opposite direction of the one surface to which the first terminal unit and the second terminal unit extend.

The assembly housing may be formed of a material having rigidity. The battery cell may include a pouch-type outer casing, and at least one electrode assembly accommodated in the outer casing, the at least one electrode connected to the electrode lead.

The first busbar member may include a first connection region connected to the first electrode lead, and a first bent region bent, and extending from the first connection region, the first bent region connected to the first terminal unit. The second busbar member may include a second connection region connected to the second electrode lead, and a second bent region bent, and extending from the second connection region, the second bent region connected to the second terminal unit.

The first bent region and the second bent region may be disposed to be parallel with the open slot formed in the assembly housing by opening the other surface of the assembly housing to connect the accommodation space in which the battery cell is accommodated to the outside of the accommodation space.

The first terminal unit may include a first terminal disposed on the one surface of the assembly housing, and a first insulating member in contact with the first terminal and the assembly housing. The second terminal unit may include a second terminal disposed on the one surface of the assembly housing to be spaced apart from the first terminal, and a second insulating member in contact with the second terminal and the assembly housing.

The first terminal and the first busbar member may be integrally formed. The second terminal and the second busbar member may be integrally formed.

At least one battery cell, among a plurality of battery cells, may be fixed to the assembly housing.

Another aspect of the disclosed technology provides a battery pack including a plurality of battery cell assemblies.

In some embodiments of the disclosed technology, a battery pack may include a pack housing, and a plurality of battery cell assemblies disposed in the pack housing.

The pack housing may include a first ventilation passage disposed to oppose or face an open slot formed in the assembly housing by opening the other surface of the assembly housing to connect an accommodation space in which a battery cell is accommodated to the outside of the accommodation space, the first ventilation passage is in communication with the open slot.

The pack housing may include a base plate disposed to oppose or face the open slot, and a side plate disposed to oppose or face the first electrode lead or the second electrode lead. The side plate may include a first hollow portion formed therein, a first ventilation hole connected to the first hollow portion, and an external ventilation hole connecting the first hollow portion to the outside of the side plate. The assembly housing may include a second ventilation hole disposed to oppose or face the first ventilation hole.

The base plate may include a first ventilation passage formed therein, and a third ventilation hole connected to the first ventilation passage, the third ventilation hole in communication with the outside of the base plate. The assembly housing may be mounted on the base plate such that the open slot is connected to the third ventilation hole.

The base plate may further include a first cooling passage formed therein to oppose or face the battery cell accommodated in the assembly housing.

The battery pack may further include a cooling plate in contact with the base plate, the cooling plate having a second cooling passage formed therein.

In an embodiment of the disclosed technology, a battery cell assembly or battery pack may have improved manufacturing efficiency and ease of mass production.

In an embodiment of the disclosed technology, a manufactured battery cell assembly or battery pack may have improved reliability in use.

### BRIEF DESCRIPTION OF DRAWINGS

Certain aspects, features, and advantages of the disclosed technology are illustrated by the following detailed description with reference to the accompanying drawings.

FIG. 1 is a partially exploded perspective view of a battery cell assembly based on an embodiment of the disclosed technology.

FIG. 2 is a partial cutaway view of a battery cell based on an embodiment of the disclosed technology.

FIG. 3 is a cross-sectional view in a longitudinal direction of a battery cell of a battery cell assembly based on an embodiment of the disclosed technology.

FIG. 4 is a perspective view of a battery cell assembly based on an embodiment of the disclosed technology.

FIG. 5 is a cross-sectional view of a first electrode lead and a first busbar member based on an embodiment of the disclosed technology.

FIG. 6 is a partial cross-sectional view of a battery cell assembly based on an embodiment of the disclosed technology.

FIG. 7 is a partial cross-sectional view of a battery cell assembly based on another embodiment of the disclosed technology.

FIG. 8 is a partially exploded perspective view of a battery pack based on an embodiment of the disclosed technology.

FIG. 9 is a cross-sectional view of the pack housing and assembly housing illustrated in FIG. 8.

FIG. 10 is a cross-sectional view of a pack housing and an assembly housing based on another embodiment of the disclosed technology.

FIG. 11 is a cross-sectional view of a pack housing and an assembly housing based on another embodiment of the disclosed technology.

FIG. 12 is a cross-sectional view of a pack housing and an assembly housing based on another embodiment of the disclosed technology.

FIG. 13 is a cross-sectional view of a pack housing and an assembly housing based on another embodiment of the disclosed technology.

### DETAILED DESCRIPTION

Features of the disclosed technology disclosed in this patent document are described by example embodiments with reference to the accompanying drawings. However, the disclosed technology is not limited to specific embodiments.

The disclosed technology can be implemented in some embodiments to provide a battery cell assembly and a battery pack including the battery cell assembly.

In some embodiments of the disclosed technology, an X-axis may indicate a width direction of a battery cell, a Y-axis may indicate a thickness direction of the battery cell, and a Z-axis may indicate a height direction of the battery cell.

A battery pack may be formed by stacking a plurality of secondary battery cells. The number and shape of secondary battery cells included in the battery pack may be appropriately selected in consideration of an output of a device to which the battery pack is applied, an energy density to be achieved, etc.

The disclosed technology can be implemented in some embodiments to improve manufacturing efficiency, facilitate mass production, and improve reliability of a battery pack.

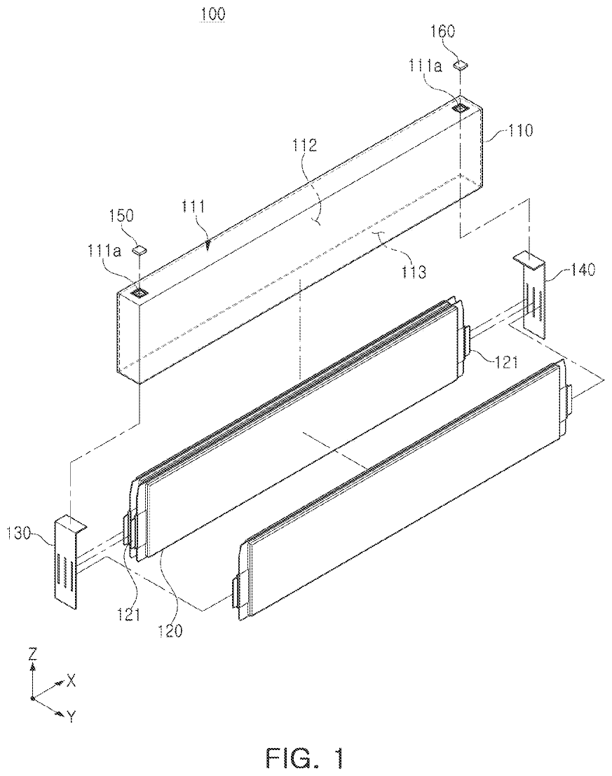

FIG. 1 is a partially exploded perspective view of a battery cell assembly 100 based on an embodiment of the disclosed technology.

As illustrated in FIG. 1, the battery cell assembly 100 based on an embodiment of the disclosed technology may be in the form of a plurality of battery cells 120 accommodated in an assembly housing 110.

An outer casing 122 of the battery cell 120 may have one folded side, and opposite ends of the folded outer casing 122 may be sealed to each other, such that the outer casing 122 may be a pouch-type outer casing. An electrode assembly (not illustrated), an electrolyte solution, and others may be present in the sealed outer casing 122. The outer casing 122 may include a film formed of a material such as aluminum.

One-side electrode lead 121 of the battery cell 120 may extend toward one side surface of the outer casing 122, and the other-side electrode lead 121 of the battery cell 120 may extend toward the other side surface of the outer casing 122. A plurality of electrode leads 121 may extend from the outer casing 122 in different directions.

A first busbar unit 130 may be connected to the one-side electrode lead 121 of the battery cell 120, and a second busbar unit 140 may be connected to the other-side electrode lead 121. The first busbar unit 130 and the second busbar unit 140 may connect a plurality of battery cells 120 to each other in series or parallel. A form of electrical connection between the battery cells 120, such as series connection or parallel connection, may be selected depending on specifications of the battery cell assembly 100 or the like, and is not necessarily limited by the disclosed technology.

The plurality of battery cells 120, the first busbar unit 130, and the second busbar unit 140 may be accommodated in an accommodation space 112 of the assembly housing 110.

The assembly housing 110 may include the accommodation space 112 for accommodating the plurality of battery cells 120, the first busbar unit 130, and the second busbar unit 140, and at least one of surfaces of the assembly housing 110 may be open.

In an embodiment of the disclosed technology, one of two surfaces of the assembly housing 110, disposed to be parallel with an X-Y plane, may be open. The open surface of the assembly housing 110 may be an open slot 113. The open slot 113 may serve to connect the accommodation space 112 of the assembly housing 110 to the outside of the assembly housing 110.

The plurality of battery cells 120, connected to the first busbar unit 130 and the second busbar unit 140, may be accommodated in the accommodation space 112 through the open slot 113 of the assembly housing 110 to assemble the battery cell assembly 100. In this way, manufacturing efficiency of the battery cell assembly 100 may be improved and mass production can be facilitated. In addition, the assembly housing 110 in which the plurality of battery cells 120 are accommodated may be directly assembled into a battery pack housing (not illustrated) or a battery mounting portion (not illustrated) of a mechanical device such as an electric vehicle, thereby improving the productivity of mechanical devices using batteries. In addition, a battery pack (not illustrated) may be completed by mounting the battery cell assembly 100 on the battery mounting portion (not illustrated) of the battery pack housing (not illustrated) even without modularizing the battery cell assembly 100. Accordingly, in some embodiments of the disclosed technology, cell-to-pack technology can be implemented by forming a plurality of battery cells directly into a pack without modularizing the plurality of battery cells.

The open slot 113 of the assembly housing 110 may be used as a cooling means for the battery cell 120. For example, the open slot 113 may be used as a passage for allowing a refrigerant, present outside of the assembly housing 110, to enter and exit the accommodation space 112.

The assembly housing 110 may be formed of a material having rigidity. In an embodiment of the disclosed technology, the assembly housing 110 may be formed of a material including metal, such that not only the battery cell 120 may be protected from external impacts, but also a fire, occurring in the assembly housing 110, may be prevented from spreading to another assembly housing 110, thereby contributing to blocking thermal runaway and thermal propagation of the battery cell assembly 100.

The assembly housing 110 may include a plurality of terminal connection holes 111a formed in a first surface 111 thereof opposite the open slot 113 while being parallel with the open slot 113. The plurality of terminal connection holes 111a may be through-holes formed in the assembly housing 110.

A first terminal unit 150, which is connected to the first busbar unit 130, may be disposed in one terminal connection hole 111a, and a second terminal unit 160, which is connected to the second busbar unit 140, may be disposed in another terminal connection hole 111a. The plurality of terminal connection holes 111a may be spaced apart from each other in an X-axis direction in the assembly housing 110. Accordingly, the first terminal unit 150 and the second terminal unit 160 may be spaced apart from each other in the assembly housing 110, and the first terminal unit 150 and the second terminal unit 160 may be insulated from each other.

When the first terminal unit 150 and the second terminal unit 160 extend from the same surface of the assembly housing 110, assembly of the battery pack may be facilitated and ease of use of the battery pack may be improved, when forming the battery pack with the battery cell assembly 100. In addition, maintenance of the first terminal unit 150 and the second terminal unit 160 is possible even without disassembling the battery cell assembly 100 or the battery pack.

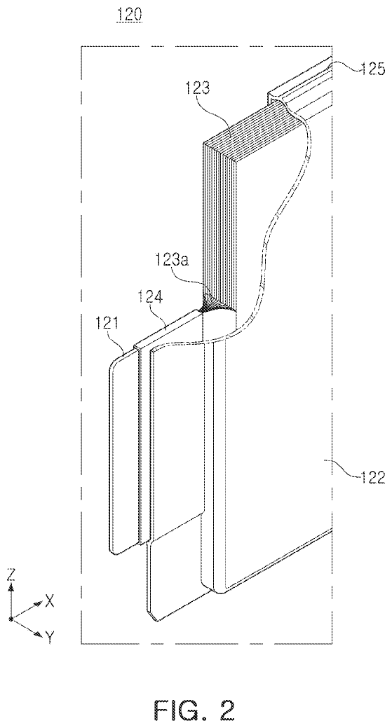

FIG. 2 is a partial cutaway view of a battery cell 120 based on an embodiment of the disclosed technology.

As illustrated in FIG. 2, the battery cell 120 based on an embodiment of the disclosed technology may include an electrode assembly 123 accommodated in an outer casing 122. The electrode assembly 123 may be formed by alternately stacking a plurality of positive electrode plates and a plurality of negative electrode plates and disposing a separator between the positive and negative electrode plates. Cell tabs 123a may respectively extend from the plurality of positive electrode plates and the plurality of negative electrode plates. A plurality of cell tabs 123a may be integrated into one electrode lead 121, and at least a portion of the electrode lead 121 may extend toward the outside of the outer casing 122. In this case, a lead insulating member 124 may be disposed between the electrode lead 121 and the outer casing 122.

As described above, the outer casing 122 may include a sealing portion 125 formed by folding one side of a film and sealing opposite ends of the folded film. The outer casing 122 may be sealed by the sealing portion 125. In the sealed outer casing 122, the electrode assembly 123 may be impregnated with an electrolyte solution.

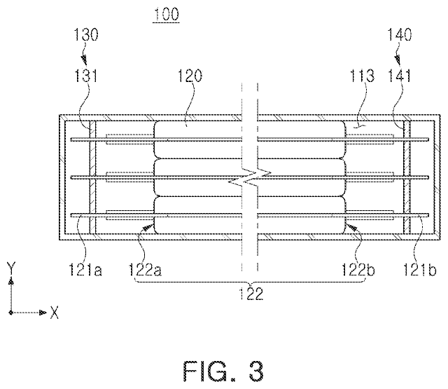

FIG. 3 is a cross-sectional view in a longitudinal direction of a battery cell 120 of a battery cell assembly 100 based on an embodiment of the disclosed technology.

As illustrated in FIG. 3, a plurality of battery cells 120 may be disposed in an accommodation space 112. Among the plurality of battery cells 120, a pair of outermost battery cells 120 may be respectively fixed to an internal surface of the assembly housing 110. In addition, another battery cell 120, disposed between a pair of battery cells 120, may be fixed to the pair of outermost battery cells 120.

In an embodiment of the disclosed technology, a tape, pad, adhesive, or the like may be used or a hot-melting method may be used to fix the pair of battery cells 120 to the assembly housing 110 or to fix the plurality of battery cells 120 to each other, thereby preventing the plurality of battery cells 120 from slipping against each other or the battery cell 120 from being separated from the assembly housing 110.

An electrode lead 121 of the battery cell 120 may include a first electrode lead 121a, which extends in an opposite direction of a first line segment 122a of an outer casing 122, and a second electrode lead 121b, which extends in an opposite direction of a second line segment 122b of the outer casing 122. The first line segment 122a, the second line segment 122b, and a Y-axis of the outer casing 122 may be disposed to be parallel with each other.

The first busbar unit 130 may include a first busbar member 131 connected to the first electrode lead 121a, and the second busbar unit 140 may include a second busbar member 141 connected to the second electrode lead 121b. In an embodiment of the disclosed technology, the first busbar member 131 and the first electrode lead 121a may be connected to each other by welding, and the second busbar member and the second electrode lead 121b may also be connected to each other by welding.

The first busbar member 131 and the second busbar member 141 may be in contact with or may not be in contact with the internal surface of the assembly housing 110. When the first busbar member 131 and the second busbar member 141 are in contact with the internal surface of the assembly housing 110, a contact portion may include an insulator (not illustrated).

An area of a square, bordering the internal surface of the assembly housing 110, in an X-Y plane may be equal to an area of an open slot (113 in FIG. 1). The internal surface of the assembly housing 110 may be present outside of an outer periphery of the plurality of battery cells 120. Accordingly, the area of the open slot (113 in FIG. 1) in the X-Y plane may be wider than the area of the plurality of battery cells 120 in the X-Y plane, thereby easily accommodating the plurality of battery cells 120 in the assembly housing 110.

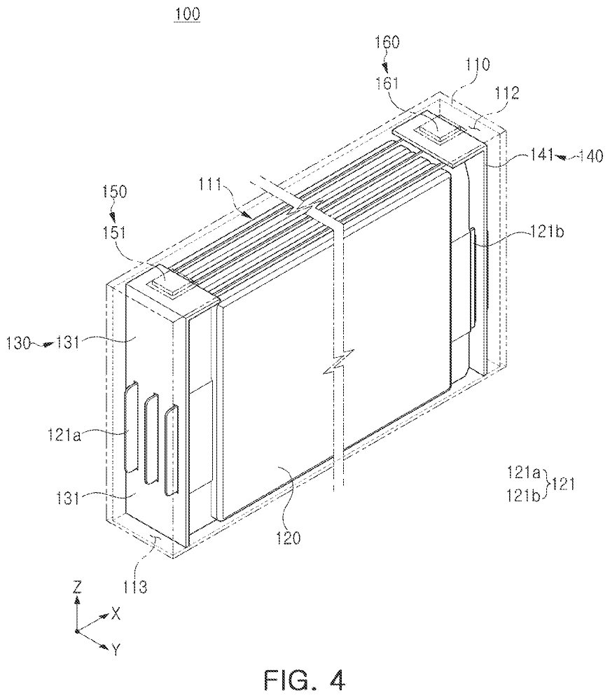

FIG. 4 is a perspective view of a battery cell assembly 100 based on an embodiment of the disclosed technology.

As illustrated in FIG. 4, a first terminal unit 150 and a second terminal unit 160 may be disposed on a first surface 111 of an assembly housing 110. The first terminal unit 150 may include a first terminal 151 disposed on one side of the first surface 111, and the second terminal unit 160 may include a second terminal 161 disposed on the other side of the first surface 111. The first terminal 151 and the second terminal 161 may be spaced apart from each other and insulated from each other.

The first busbar member 131 may include one end bent and extending in an +X-direction, and an extending region may be in contact with the first terminal 151. In addition, the second busbar member 141 may include one end bent and extending in an −X-direction, and an extending region may be in contact with the second terminal 161.

A bottom surface of the battery cell assembly 100 discussed above may include an open slot 113, and the first terminal 151 and the second terminal 161 may extend toward the first surface 111 oriented in an opposite direction of the open slot 113. When forming a battery pack (not illustrated) with a plurality of battery cell assemblies 100, the open slot 113 of the battery cell assembly 100 may be disposed opposite a bottom surface of a battery pack housing (not illustrated), and the first surface 111 of the assembly housing 110 may be disposed opposite an open portion of the battery pack housing (not illustrated). Accordingly, the first terminal 151 and the second terminal 161 are present in the open portion of the pack housing (not illustrated), thereby easily performing an operation for electrical coupling between battery cell assemblies 100 through the first terminal 151 and the second terminal 161. In addition, when a maintenance operation, such as replacement of the first terminal 151 and the second terminal 161, is performed, the maintenance operation of the battery cell assembly 100 and the battery pack may be performed even without separating the battery cell assembly 100 from the pack housing (not illustrated).

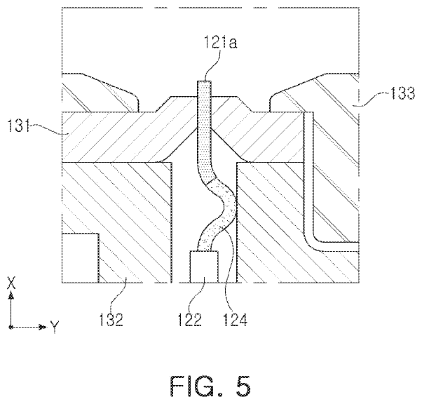

FIG. 5 is a cross-sectional view of a first electrode lead 121a and a first busbar member 131 based on an embodiment of the disclosed technology.

As illustrated in FIG. 5, the first busbar member 131 may be connected to a first electrode lead 121a, and the first busbar member 131 and the first electrode lead 121a may be welded to each other.

The first electrode lead 121a may be connected to an electrode assembly (123 in FIG. 2) accommodated in the outer casing 122 to be exposed to the outside of the outer casing 122. An exposed region of the first electrode lead 121a may be welded to the first busbar member 131. In this case, a lead insulating member 124 may be disposed between the outer casing 122 and the first electrode lead 121a to insulate the outer casing 122 and the first electrode lead 121a from each other.

A busbar insulating member 132 may be disposed on a lower portion of the first busbar member 131 in an −X-direction. The busbar insulating member 132 may include a plastic resin or injection molded material. The busbar insulating member 132 may perform an insulating function of the first busbar member 131 while firmly supporting the first busbar member 131.

The first busbar member 131 may be easily fixed to the busbar insulating member 132 by a busbar fixing member 133, passing through the first busbar member 131 and the busbar insulating member 132 in an X-axis direction. The busbar fixing member 133 may include a bolt or any other structure that can be used to fasten objects together, but the disclosed technology is not necessarily limited thereto. In addition, the above-described busbar insulating member 132 and busbar fixing member 133 may be applied to a second busbar member (141 in FIG. 4) based on the embodiments discussed above.

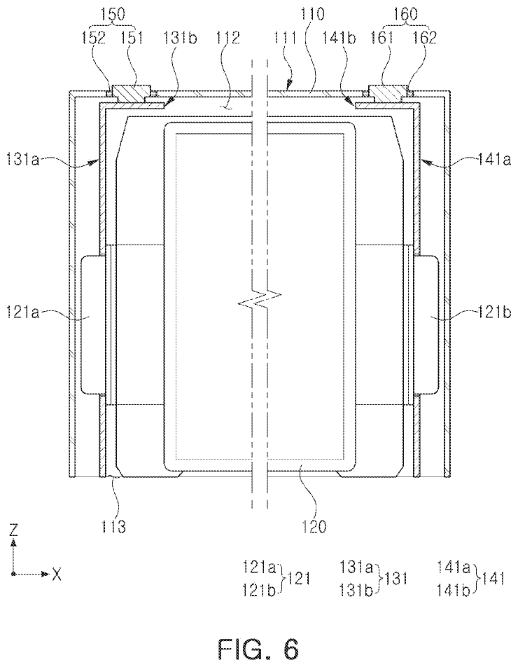

FIG. 6 is a partial cross-sectional view of a battery cell assembly based on an embodiment of the disclosed technology.

As illustrated in FIG. 6, a first busbar member 131 may include a first connection region 131a connected to a first electrode lead 121a, and a first bent region 131b bent and extending from the first connection region 131a in an +X-direction, the first bent region 131b connected to a first terminal 151. The first terminal 151 may be supported on an assembly housing 110 by a first insulating member 152.

The second busbar member 141 may include a second connection region 141a connected to a second electrode lead 121b, and a second bent region 141b bent and extending from the second connection region 141a in an −X-direction, the second bent region 141b connected to a second terminal 161. The second terminal 161 may be supported on the assembly housing 110 by a second insulating member 162.

The first terminal 151 and the second terminal 161 may be disposed on a first surface 111 of the assembly housing 110. The first bent region 131b and the second bent region 141b both may be disposed to be parallel with an open slot 113, and the first bent region 131b, the second bent region 141b, and the open slot 113 may be disposed to be parallel with an X-axis. Accordingly, when the assembly housing 110 is mounted in a pack housing (not illustrated) such that the open slot 113 opposes or faces a bottom surface of the pack housing (not illustrated), the first terminal 151 and the second terminal 161 may be positioned in an open upper portion of the pack housing (not illustrated).

Accordingly, electrical connection between the first terminal 151 and the second terminal 161 may be made and a maintenance operation may be performed even without separating the battery cell 120 from the pack housing (not illustrated).

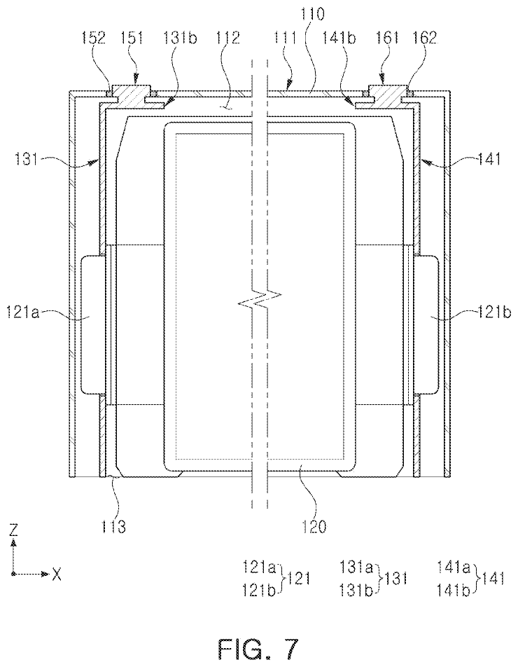

FIG. 7 is a partial cross-sectional view of a battery cell assembly based on another embodiment of the disclosed technology.

As illustrated in FIG. 7, in another embodiment of the disclosed technology, a first busbar member 131 and a first terminal 151 may be integrally formed. In addition, a second busbar member 141 and a second terminal 161 may also be integrally formed.

In some implementations, a process of assembling a terminal and a busbar member may be omitted, and thus manufacturing efficiency may be further improved and mass production of a battery cell assembly or battery pack may be further facilitated.

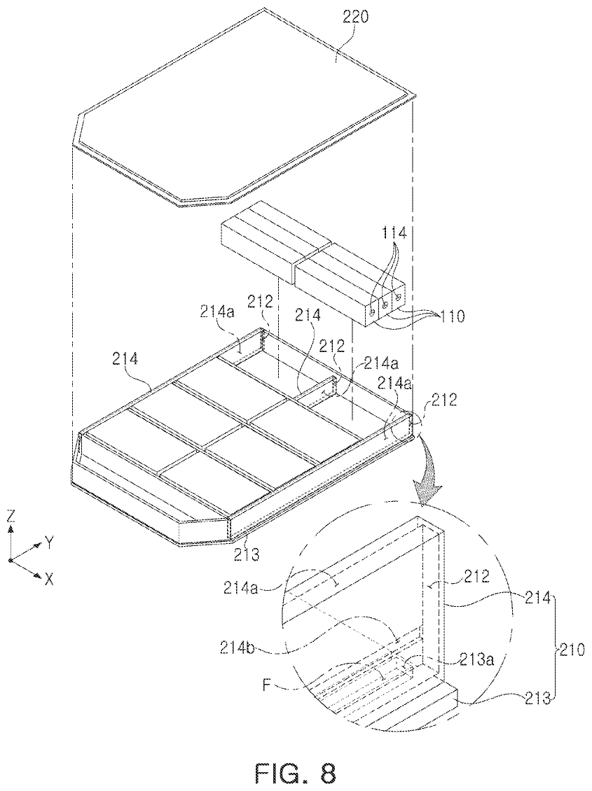

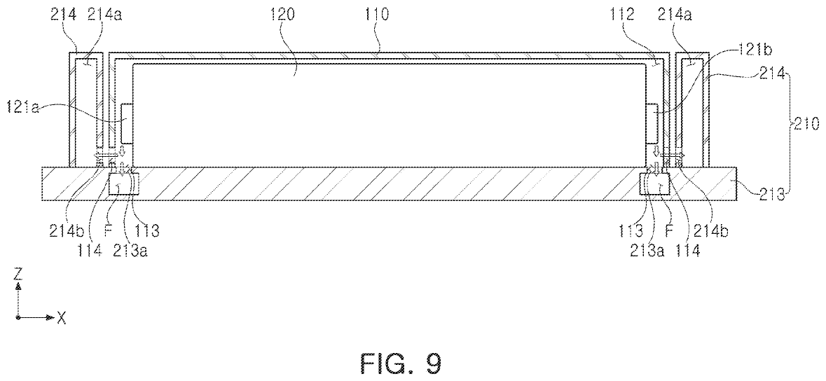

FIG. 8 is a partially exploded perspective view of a battery pack based on an embodiment of the disclosed technology. FIG. 9 is a cross-sectional view of the pack housing 210 and assembly housing 110 illustrated in FIG. 8.

As illustrated in FIGS. 8 and 9, a battery pack based on an embodiment of the disclosed technology may include a pack housing 210 and a plurality of battery cell assemblies (100 in FIG. 4) mounted on the pack housing 210. The pack housing 210 may include a base plate 213 and a side plate 214 connected to the base plate 213. A plurality of side plates 214 may be provided, and may define a space in which the battery cell assembly (100 in FIG. 4) is mounted.

The base plate 213 may oppose or face an open slot (113 in FIG. 7) of an assembly housing 110 and may support a bottom surface of the assembly housing 110. The base plate 213 may include a first ventilation passage F therein. The first ventilation passage F may oppose or face the open slot (113 in FIG. 7) of the assembly housing 110, and ventilation gas, discharged from the open slot (113 in FIG. 7) of the assembly housing 110, may flow into the first ventilation passage F.

The base plate 213 may include a third ventilation hole 213a connected to the first ventilation passage F and connected to the outside of the base plate 213. Accordingly, the ventilation gas, present in the first ventilation passage F, may be discharged to the outside of the base plate 213.

The assembly housing 110 may be mounted on the base plate 213 such that the open slot (113 in FIG. 7) opposes or faces the third ventilation hole 213a of the base plate 213. In addition, the assembly housing 110 may include a second ventilation hole 114 on a surface thereof, opposing the side plate 214. The second ventilation hole 114 may be a hole, passing through the assembly housing 110, and may be a passage, connecting the inside of the assembly housing 110 and the outside of the assembly housing 110 to each other. Accordingly, ventilation gas generated in the assembly housing 110 may be discharged to the outside of the assembly housing 110 through the second ventilation hole 114.

The side plate 214 may be disposed to intersect the base plate 213, and may be disposed to intersect an electrode lead (121 in FIG. 7) of a battery cell (120 in FIG. 7). The side plate 214 may include a hollow therein, and the hollow may be a first hollow portion 214a of the side plate 214. The side plate 214 may include a first ventilation hole 214b connected to the first hollow portion 214a, and the first ventilation hole 214b may be formed on a side surface of the side plate 214. The first ventilation hole 214b may oppose or face the second ventilation hole 114 of the assembly housing 110, and accordingly, the ventilated gas, generated in the assembly housing 110, may flow into the first ventilation hole 214b through the second ventilation hole 114.

An end of the side plate 214 may include an external ventilation hole 212 connected to the first hollow portion 214a. The external ventilation hole 212 may be a passage connecting the first hollow portion 214a to the outside of the side plate 214. Accordingly, gas that is generated in the assembly housing 110 may be discharged through the second ventilation hole 114 toward the first hollow portion 214a through the first ventilation hole 214b of the side plate 214. Subsequently, the ventilated gas may be discharged to the outside of the side plate 214 through the external ventilation hole 212. In this way, the gas generated in the assembly housing 110 may be discharged to lower and side portions of the assembly housing 110, and thus may be rapidly discharged. In addition, the hollow portion may have a relatively large volume within the pack housing 210, thereby reducing the weight of the pack housing 210.

The pack housing 210 may further include a pack cover member 220 structured to cover an upper portion of the assembly housing 110. The pack cover member 220 may serve to protect components present in the pack housing 210. In addition, when a fire occurs, the pack cover member 220 may also prevent flames generated in the pack housing 210 from spreading to the outside of the pack housing 210.

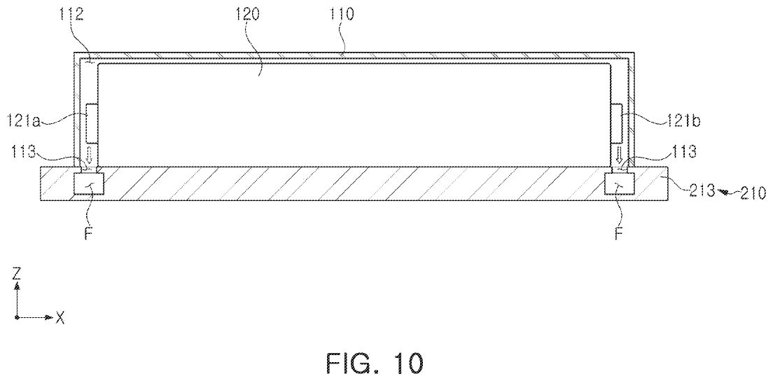

FIG. 10 is a cross-sectional view of a pack housing 210 and an assembly housing 110 based on another embodiment of the disclosed technology.

As illustrated in FIG. 10, the assembly housing 110 may be mounted on the pack housing 210 such that an open slot 113 opposes or faces the pack housing 210.

The pack housing 210 may include a base plate 213 opposing or facing the open slot 113 of the assembly housing 110, the base plate 213 on which the assembly housing 110 is mounted.

The base plate 213 may include a hollow therein, and the hollow of the base plate 213 may be a first ventilation passage F. The first ventilation passage F may be formed in the base plate 213 to be continuous in a direction (Y-axis direction in FIG. 8) in which the assembly housing 110 is stacked. The first ventilation passage F may be formed to be in communication with the base plate 213 and the outside. Accordingly, ventilation gas, present in the receiving space 112 of the assembly housing 110, may flow into the first ventilation passage F through the open slot 113, and may then be rapidly discharged to the outside of the base plate 213. Such a structure may be useful when the pack housing 210 includes only the base plate 213.

In this case, when attempting to ventilate through a side surface of the assembly housing 110, a ventilation opening or hole (not illustrated) may also be added to the side surface of the assembly housing 110. In addition, the assembly housing 110 based on some embodiments of the disclosed technology may protect a side surface of a battery cell 120. Accordingly, even when a side plate 214, surrounding an outermost side of the battery cell 120, is not separately provided, the battery cell 120 may be protected from external impacts.

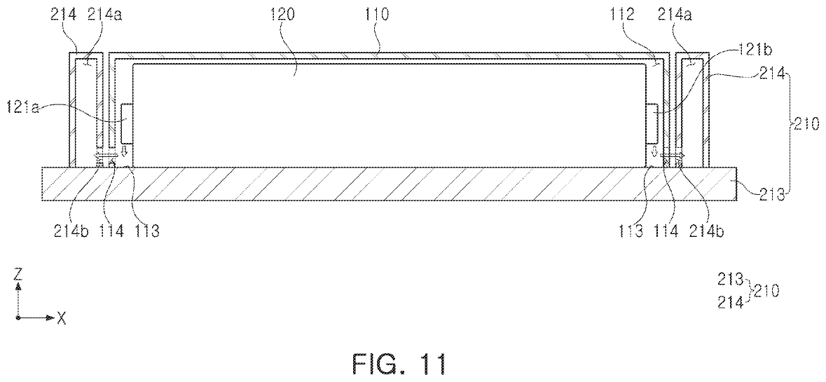

FIG. 11 is a cross-sectional view of a pack housing 210 and an assembly housing 110 based on another embodiment of the disclosed technology.

As illustrated in FIG. 11, in another embodiment of the disclosed technology, the assembly housing 110 may have a second ventilation hole 114 on a side surface thereof. The second ventilation hole 114 may be a hole passing through the assembly housing 110, and may connect an accommodation space 112 of the assembly housing 110 to the outside of the assembly housing 110.

In another embodiment of the disclosed technology, the pack housing 210 may include a side plate 214, opposing or facing a side surface of the assembly housing 110, and a base plate 213, opposing or facing an open slot 113 of the assembly housing 110.

First, the side plate 214 may have, therein, a first hollow portion 214a and a first ventilation hole 214b connected to the first hollow portion 214a, the first ventilation hole 214b opposing or facing the second ventilation hole 114. The first hollow portion 214a may be in communication with the outside of the side plate 214. Accordingly, ventilated gas, discharged through the second ventilation hole 114, may flow into the first ventilation hole 214b to be discharged to the outside of the side plate 214. In this way, the ventilation through a side surface of a battery cell 120 may be facilitated.

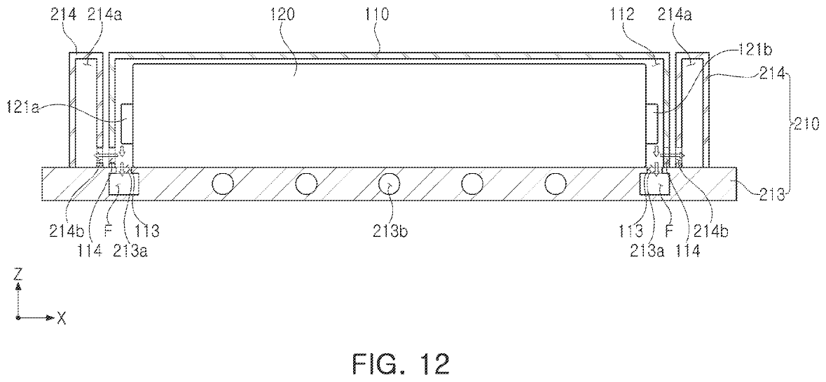

FIG. 12 is a cross-sectional view of a pack housing 210 and an assembly housing 110 based on another embodiment of the disclosed technology.

As illustrated in FIG. 12, in another embodiment of the disclosed technology, a base plate 213 may further have a first cooling passage 213b formed therein to oppose or face a battery cell 120 accommodated in the assembly housing 110. A plurality of first cooling passages 213b may be formed in the base plate 213, and may be formed to be continuous in a direction (Y-axis direction in FIG. 8) in which the battery cells 120 are stacked.

In some implementations, a refrigerant may be present in the first cooling passage 213b, and the refrigerant may be provided to circulate through the first cooling passage 213b. To this end, devices (not illustrated) for refrigerant circulation may be connected to the first cooling passage 213b.

The first cooling passage 213b may be formed to be adjacent to a first ventilation passage F in the base plate 213, and the first cooling passage 213b may be formed to oppose or face the first ventilation passage F and the battery cell 120. Accordingly, a bottom surface of the battery cell 120 may be cooled, and ventilation gas may be cooled before the ventilation gas is discharged to the outside of the pack housing 210.

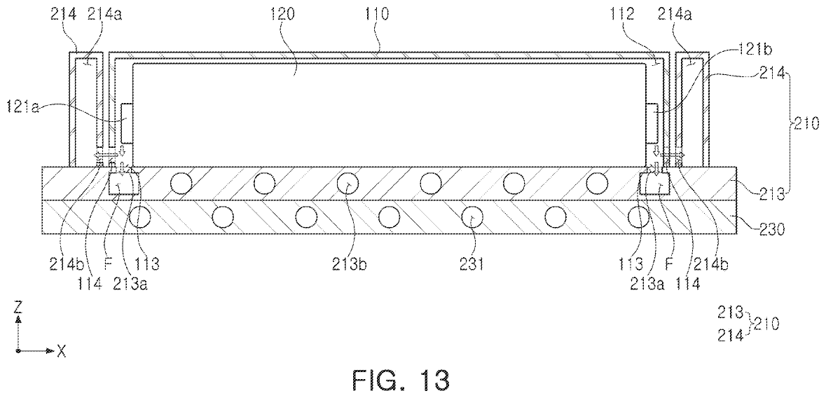

FIG. 13 is a cross-sectional view of a pack housing 210 and an assembly housing 110 based on another embodiment of the disclosed technology.

As illustrated in FIG. 13, a cooling plate 230 may be further provided on a lower portion of a base plate 213. The cooling plate 230 may be in contact with the base plate 213 to exchange heat with the base plate 213.

In an embodiment of the disclosed technology, the cooling plate 230 may include a plurality of second cooling passages 231 therein. A refrigerant may be present in the second cooling passage 231 or the refrigerant may be provided to circulate through the second cooling passage 231. In addition, the second cooling passage 231 may be formed on the cooling plate 230 to be misaligned with the first cooling passage 213b in a Z-axis direction. Accordingly, the base plate 213 may have improved cooling efficiency, thereby improving the cooling efficiency of the battery cell 120 and ventilation gas.

The disclosed technology can be implemented in, and to manufacture, various electrochemical devices such as rechargeable secondary batteries, battery cell assemblies and battery packs that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to provide improved rechargeable secondary batteries, battery cell assemblies and battery packs used in various power sources and power supplies, thereby mitigating climate changes in connection with uses of power sources and power supplies. Lithium secondary batteries based on the disclosed technology can be used to address various adverse effects such as air pollution and greenhouse emissions by powering electric vehicles (EVs) as alternatives to vehicles using fossil fuel-based engines and by providing battery-based energy storage systems (ESSs) to store renewable energy such as solar power and wind power.

Only specific examples of implementations of certain embodiments are described. Variations, improvements and enhancements of the disclosed embodiments and other embodiments may be made based on the disclosure of this patent document.

What is claimed is:

1. A battery cell assembly comprising:
an assembly housing including an accommodation space and an open slot;
a battery cell accommodated in the accommodation space of the assembly housing and including a first electrode lead and a second electrode lead;
a first busbar member and a second busbar member accommodated in the assembly housing, the first busbar member connected to the first electrode lead and the second busbar member connected to the second electrode lead; and
a first terminal unit connected to the first busbar member and a second terminal unit connected to the second busbar member,
wherein a portion of the first terminal unit and a portion of the second terminal unit extend toward a first surface of the assembly housing such that the portions of the first terminal unit and the second terminal unit are disposed outside of the assembly housing,
wherein the open slot is formed by opening a second surface of the assembly housing to connect the accommodation space to the outside of the accommodation space, and
wherein the open slot is formed in the assembly housing to be oriented in an opposite direction of the first surface of the assembly housing.

2. The battery cell assembly of claim 1, wherein the assembly housing includes a material having predetermined rigidity, and
the battery cell includes:
a pouch-type outer casing; and
at least one electrode assembly accommodated in the outer casing, the at least one electrode connected to the electrode lead.

3. The battery cell assembly of claim 1, wherein the first busbar member includes:
a first connection region connected to the first electrode lead; and
a first bent region bent and extending from the first connection region, the first bent region connected to the first terminal unit, and
the second busbar member includes:
a second connection region connected to the second electrode lead; and
a second bent region bent and extending from the second connection region, the second bent region connected to the second terminal unit.

4. The battery cell assembly of claim 3, wherein the first bent region and the second bent region are disposed to be parallel with the open slot formed in the assembly housing by opening the second surface of the assembly housing to connect the accommodation space in which the battery cell is accommodated to the outside of the accommodation space.

5. The battery cell assembly of claim 4, wherein
the first terminal unit includes:
a first terminal disposed on the first surface of the assembly housing; and
a first insulating member in contact with the first terminal and the assembly housing, and
the second terminal unit includes:
a second terminal disposed on the first surface of the assembly housing to be spaced apart from the first terminal; and
a second insulating member in contact with the second terminal and the assembly housing.

6. The battery cell assembly of claim 5, wherein the first terminal and the first busbar member are integrally formed, and
the second terminal and the second busbar member are integrally formed.

7. The battery cell assembly of claim 1, wherein the battery cell is fixed to the assembly housing.

8. A battery pack comprising:
a pack housing; and
a plurality of battery cell assemblies, wherein each battery cell assembly comprises:
an assembly housing including an accommodation space and an open slot;
a battery cell accommodated in the accommodation space of the assembly housing and including a first electrode lead and a second electrode lead;
a first busbar member and a second busbar member accommodated in the assembly housing, the first busbar member connected to the first electrode lead and the second busbar member connected to the second electrode lead; and
a first terminal unit connected to the first busbar member and a second terminal unit connected to the second busbar member,
wherein a portion of the first terminal unit and a portion of the second terminal unit extend toward a first surface of the assembly housing such that the portions of the first terminal unit and the second terminal unit are disposed outside of the assembly housing,
wherein the open slot is formed by opening a second surface of the assembly housing to connect the accommodation space to the outside of the accommodation space, and
wherein the open slot is formed in the assembly housing to be oriented in an opposite direction of the first surface of the assembly housing.

9. The battery pack of claim 8, wherein the assembly housing includes a material having predetermined rigidity, and
the battery cell includes:
a pouch-type outer casing; and
at least one electrode assembly accommodated in the outer casing, the at least one electrode connected to the electrode lead.

10. The battery pack of claim 8, wherein the first busbar member includes:
a first connection region connected to the first electrode lead; and
a first bent region bent and extending from the first connection region, the first bent region connected to the first terminal unit, and
the second busbar member includes:
a second connection region connected to the second electrode lead; and
a second bent region bent and extending from the second connection region, the second bent region connected to the second terminal unit.

11. The battery pack of claim 10, wherein the first bent region and the second bent region are disposed to be parallel with the open slot formed in the assembly housing by opening the second surface of the assembly housing to connect the accommodation space in which the battery cell is accommodated to the outside of the accommodation space.

12. The battery pack of claim 11, wherein
the first terminal unit includes:
a first terminal disposed on the first surface of the assembly housing; and
a first insulating member in contact with the first terminal and the assembly housing, and
the second terminal unit includes:
a second terminal disposed on the first surface of the assembly housing to be spaced apart from the first terminal; and
a second insulating member in contact with the second terminal and the assembly housing.

13. The battery pack of claim 12, wherein the first terminal and the first busbar member are integrally formed, and
the second terminal and the second busbar member are integrally formed.

14. The battery pack of claim 8, wherein the battery cell is fixed to the assembly housing.

15. The battery pack of claim 8, wherein the pack housing includes a first ventilation passage disposed opposite an open slot formed in the assembly housing by opening the second surface of the assembly housing to connect an accommodation space in which a battery cell is accommodated to the outside of the accommodation space, the first ventilation passage is in communication with the open slot.

16. The battery pack of claim 15, wherein
the pack housing includes:
a base plate disposed opposite the open slot; and
a side plate disposed opposite the first electrode lead or the second electrode lead,
the side plate includes:
a first hollow portion formed therein;
a first ventilation hole connected to the first hollow portion; and
an external ventilation hole connecting the first hollow portion to the outside of the side plate, and
the assembly housing includes a second ventilation hole disposed opposite the first ventilation hole.

17. The battery pack of claim 16, wherein
the base plate includes:
a first ventilation passage formed therein; and
a third ventilation hole connected to the first ventilation passage, the third ventilation hole in communication with the outside of the base plate, and
the assembly housing is mounted on the base plate such that the open slot is connected to the third ventilation hole.

18. The battery pack of claim 16, wherein the base plate further includes a first cooling passage disposed opposite the battery cell accommodated in the assembly housing.

19. The battery pack of claim 16, further comprising:
a cooling plate in contact with the base plate, the cooling plate including a second cooling passage.
